(19) United States
(12) Patent Application Publication
(10) Pub. No.: US 2013/0322873 A1
(43) Pub. Date: Dec. 5, 2013

(54) SYSTEM AND METHOD FOR QUANTUM TELEPORTATION

(71) Applicant: KABUSHIKI KAISHA TOSHIBA, Tokyo (JP)

(72) Inventors: Richard Mark STEVENSON, Cambridge (GB); Martin Brian WARD, Cambridge (GB); Anthony John BENNETT, Cambridge (GB); Joanna Krystyna SKIBA-SZYMANSKA, Cambridge (GB); Andrew James SHIELDS, Cambridge (GB)

(73) Assignee: KABUSHIKI KAISHA TOSHIBA, Tokyo (JP)

(21) Appl. No.: 13/895,683

(22) Filed: May 16, 2013

(30) Foreign Application Priority Data
May 16, 2012 (GB) 1208640.1

(51) Int. Cl. H04B 10/07

(52) U.S. Cl. CPC H04B 10/07
USPC 398/25

(57) ABSTRACT

A system for quantum teleportation of a quantum state of an input photon, including: a light emitting diode configured to produce a polarization entangled photon pair; a beam splitter configured to direct photons of the entangled photon pair along respective first and second paths; a measurement unit performing a joint measurement on the input photon; a timing unit configured to measure a first delay between the input photon and the photon of the entangled photon pair at a point of maximum indistinguishability of the photons as they pass through the joint measurement unit, and to measure a second delay between the two photons of the entangled photon pair as they exit the light emitting diode; a controller configured to determine a teleportation measurement is valid if the first delay is within a first predetermined timing window and the second delay is within a second predetermined timing window.

### FIELD

Embodiments described herein generally relate to systems and methods for quantum teleportation.

### BACKGROUND

The ‘no-cloning’ theorem states that quantum information cannot be copied, which has profound implications for quantum information technology. The security of quantum cryptography depends directly upon it, by encoding information on single photons. However, without the ability to copy information the options to create simple quantum communication networks are limited, and in quantum computing, losses due to imperfect measurements or probabilistic logic gates can terminate a quantum algorithm. Quantum teleportation, where quantum information is destroyed so that it may be transferred simultaneously to another location, has been proposed as an elegant solution. In quantum communication networks teleportation allows a quantum channel between two nodes to be established. In quantum computing based on linear optics, the so called feed-forward technique allows probabilistic logic operations to be performed off-line on sacrificial qubits until they succeed, after which the intended input qubits can be teleported through with success probability arbitrarily close to unity.

### BRIEF DESCRIPTION OF THE DRAWINGS

FIG. 1 is a schematic of a teleportation system in accordance with an embodiment of the present invention;

FIG. 2 is a more detailed schematic of the embodiment of FIG. 1, with the measurement unit shown in more detail;

FIG. 3 is a yet more detailed schematic of FIG. 2 with the photon paths shown in more detail;

FIG. 4a is a plot of second-order-correlation against time delay between photon detection events and FIG. 4b is a Poincare sphere;

FIG. 5a is a plot of the fidelity of the teleportation of a state against the first delay time and second delay time, and FIG. 5b is the teleportation fidelity against second delay time for a first delay time of zero; and

FIG. 6 is a schematic of a teleportation system in accordance with a further embodiment of the invention.

### DETAILED DESCRIPTION

Embodiments of the present invention provide a system for quantum teleportation of a quantum state of an input photon, the system comprising:
a light emitting diode configured to produce a polarisation entangled photon pair;
a beam splitter configured to direct one photon of an entangled photon pair along a first path and the other photon of said entangled pair along a second path;
an input for said input photon;
a measurement unit for performing a joint measurement on the input photon with one of the photons of an entangled photon pair directed along the first path, the measurement unit comprising a first detector unit for detecting two photons upon which a joint measurement has been performed;
a second detector unit configured to detect the photon from said entangled photon pair directed along the second path;
a timing unit is configured to measure a first delay, said first delay being the magnitude of the delay between the input photon and the photon of the entangled photon pair at the point of maximum indistinguishability of the photons as they pass through the joint measurement unit, the timing unit being further configured to measure a second delay, said second delay being the magnitude of the time between the two photons of the entangled photon pair as they exit the light emitting diode; and
a controller configured to determine that a teleportation measurement is valid if the first delay is within a first pre-determined timing window and the second delay is within a predetermined timing window.

In an embodiment, the system further comprises an electrical source for said light emitting diode and wherein said electrical source is a D.C. source. Such a driven source provides a quasi continuous streams of anti-bunched photons.

The first delay can be measured in a number of ways, in one embodiment said timing unit is configured to determine the first delay time from the detection time of the said two photons by the first detector unit. In further embodiments, the timing unit is also configured to compensate for variations between the path lengths from the point where the respective spatial modes of the two photons meet in the joint measurement unit to the first detector unit. For example, in an embodiment, there are two detectors in the first detecting unit and the will be optical output paths leading from the point where the respective spatial modes of the two photons meet in the joint measurement unit to each of the detectors in the first detector unit. The timing unit is configured to determine the delay between the output paths and compensate for this delay.

In some embodiments, the joint measurement unit comprises a beam splitter to permit two-photon-interference and wherein said timing unit is configured to determine the first delay time from the detection time of the said two photons by the first detector unit, the timing unit also being configured to compensate for variations between the path length taken by the two photons from the beam splitter to the first detector unit. However, it should be noted that in some further embodiments, when a beam splitter is used, the joint measurement unit may be configured such that the point where the respective spatial modes of the two photons meet does not coincide with the beam splitter.

In an embodiment the first timing window will be from 0 to t₁ₘₐₓ where t₁ₘₐₓ is the coherence time of the photon which follows the first path. In some embodiments, this will be 400 ps or less, in other embodiments 200 ps or less. As it will not usually be known which photon will arrive first, in some cases the magnitude of the delay is measured.

In a further embodiment the timing unit is configured to measure the second delay from the time when the photon which follows the second path is received at the second detector, the timing unit being further configured to compensate for differences in path lengths taken by the two photons of the entangled photon pairs.

In a further embodiment, the system further comprises a blocking unit located in the second path, said timing unit being configured to operate said blocking unit to allow the transmission of a photon along the second path if the second delay time is below the second timing window

In some embodiments, said second timing window is from 0 to t₂ₘₐₓ, where t₂ₘₐₓ is of the order of the exciton radiative lifetime. For example, t₂ₘₐₓ may be 1 ns or less. Entangled photons will be produced from decay of a biexciton where a first photon is emitted due to the decay of the biexciton and then a second photon will be emitted due to the decay of the remaining exciton. The photon emitted due to decay of the biexciton will be emitted at the same time or before the photon which is emitted due to exciton decay. However, the system could be configured such that either the first or the second photon can be directed along the first path.

In a further embodiment, the system further comprises a blocking unit located in the second path, said timing unit being configured to operate said blocking unit to block the transmission of a photon along the second path unless said controller has determined that the first delay time is within the first timing window. In this embodiment, the detection of photons from the joint measurement takes place first and, if the first delay time is short enough to suggest that the joint measurement could result in teleportation of the state of the input photon, the blocking unit is configured to open to allow the transmission of the photon which follows the second path.

An electrically driven entangled light source is used. The emitted photons of such sources may have a poor coherence time. This may result in partial distinguishability between the photons which undergo the joint measurement and this can affect the possibility of successful teleportation and will thus degrade the overall quality, or fidelity, of teleported photons. In an embodiment, to improve the teleportation fidelity, the system further comprises a state measurement unit configured to perform state measurements on both of the photons which pass through the joint measurement unit and wherein the controller determines that the teleportation measurement is valid if, additionally the state measurements on both photons agree with at least one of a predetermined set of results. For example, the photons which undergo the joint teleportation measurement will be passed through polarising beam splitters in and their polarisations will be measured.

In a further embodiment, if a blocking unit it used which is configured to only allow the passage of a second photon if the first delay time is within the first timing window, the blocking unit may also be configured to only allow the passage of the second photon if the first delay time is within the first timing window and the results of the state measurement unit indicate that teleportation has occurred.

In an embodiment, the joint measurement is a measurement involving Bell states or mixtures with Bell states.

In a further embodiment, the controller is configured to allow post measurement selection of valid measurements

The first detector unit may comprise first and second detectors, the first and second detectors being superconducting detectors. These types of detectors allow high time resolution to be achieved.

The system may be configured such that the source also provides the input photon. For example, the system may further comprise an input photon delay unit and a switch, said switch being configured to direct a photon from the first path into the said input photon delay unit, wherein in the input photon delay unit, the photon from the said source is delayed to coincide with a further photon output by the source such that the photon which is delayed becomes the input photon. The polarisation state of the input photon may be modified as desired before the joint measurement in order for the state to be teleported to be selected.

In some embodiments, the state to be teleported is a superposition state.

The light emitting diode may comprise a quantum dot. In a further embodiment, the quantum dot is provided in a p-i-n diode.

The above teleportation system may be used in a number of apparatus such as a quantum computer, quantum relay etc. The teleportation may also be used for quantum communication.

Further embodiments provide a method of teleporting of a quantum state of an input photon, the method comprising:
providing a polarisation entangled photon pair from a light emitting diode;
directing one photon of the entangled photon pair along a first path and the other photon of said entangled pair along a second path;
providing an input photon;
performing a joint measurement on the input photon with one of the photons of an entangled photon pair directed along the first path and detecting the two photons upon which a joint measurement has been performed;
detecting the photon from said entangled photon pair directed along the second path;
measuring a first delay, said first delay being the magnitude of the delay between the input photon and the photon of the entangled photon pair at the point of maximum indistinguishability of the photons as they undergo joint measurement,
measuring a second delay, said second delay being the magnitude of the delay time between the two photons of the entangled photon pair as they exit the light emitting diode; and
determining that a teleportation measurement is valid if the first delay is within a first timing predetermined window and the second delay is within a second predetermined timing window.

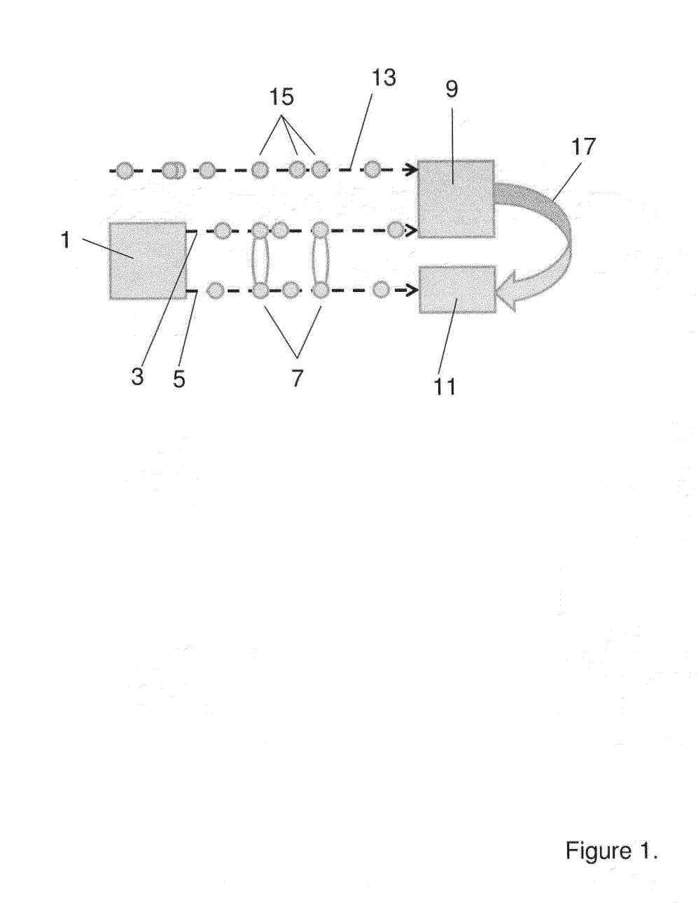

FIG. 1 shows schematically teleportation of photons from a sender, commonly referred to as Alice, to a receiver, commonly referred to as Bob.

In FIG. 1, entangled light is generated using electrically driven entangled light source 1. The electrically driven entangled light source emits the individual component photons of entangled pairs into two spatial modes 3 and 5. In the system of FIG. 1 the source is electrically driven and the electrical driving current to the source is d.c. This causes a continuous stream of single photons to be produced in each output mode. The photons streams in spatial modes 3 and 5 are anti-bunched, which means that there is suppressed probability of generating two photons in a given mode at the same time.

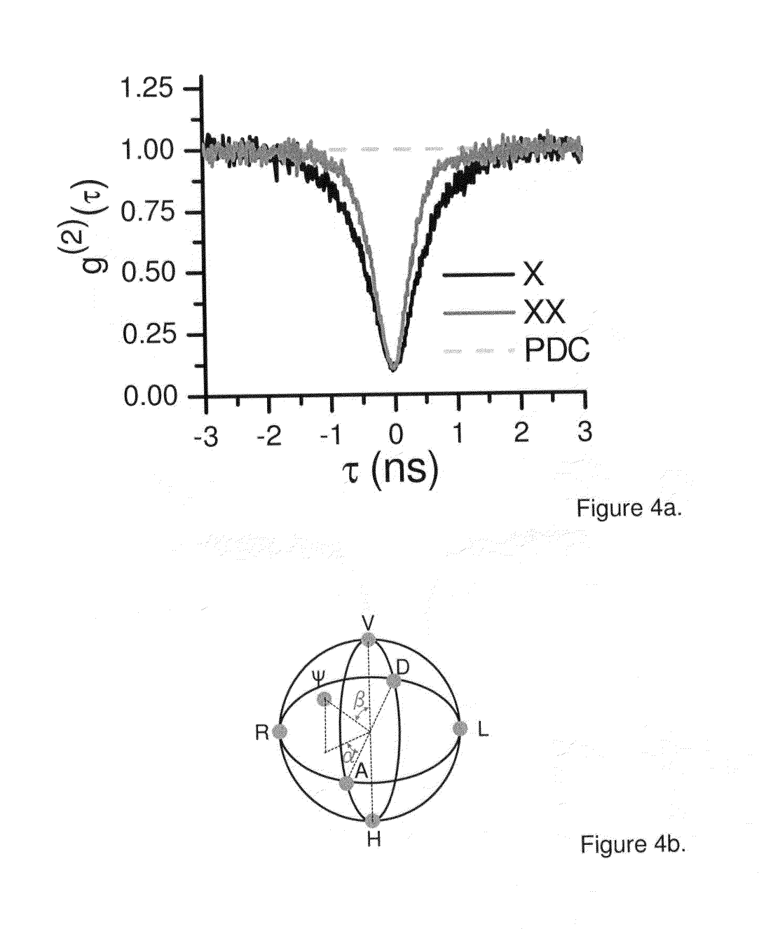

In one embodiment, the photon source comprises a semiconductor quantum dot as the active element. This type of source will be described in more detail in relation to FIG. 4.

In the system of FIG. 1, photons in modes 3 and 5 emitted at the same time from the entangled LED source (ELED), form entangled photon pairs 7. Photons in modes 3 and 5 are distributed to sender Alice 9, and receiver Bob 11 respectively. Distribution of spatial modes 3 and 5 may be achieved by free-space or fibre optic channels.

Sender Alice 9 also receives input photons 13 in a further spatial mode 15. The input photons 15 are required to have similar frequency to those in mode 3, but may be delivered in pulses or continuously, and need not be anti-bunched.

Sender Alice has a measurement unit which performs a joint measurement on two photons, one from each input modes 13 and 3. The measurement unit has a detection unit which is configured to detect both photons from input modes 13 and 3. The system also comprises a timing unit (not shown) which measures the time delay between the detection of the two photons. From this measured time delay it is possible to determine the time delay τ₁ relevant to the joint measurement process, which is the delay between the input photon and the photon of the entangled photon pair at the point of maximum indistinguishability of the photons as they pass through the joint measurement unit. In general, the joint measurement will involve passing both photons through a beam splitter. Typically the delay will be between the two photons when their spatial modes meet at a beamsplitter. In some embodiments, the photons may pass through the beam splitter at different times, but one of the photons may be delayed close to the beam splitter to allow interference to take place.

The joint measurement shall reveal no information of the qubit state of the photons, which if polarisation encoding schemes are used means that the polarisation of a photons in modes 3 and 13 is not revealed by the measurement. The joint measurement basis is selected so that after completion, the qubit state of the input photon in mode 13 may be transferred, via entanglement with a photon in mode 3, to a photon in mode 5. Examples of suitable joint measurements are joint detection of two photons, one in modes 3 and one in mode 13, in a Bell state such as (|H₃V₁₃)−|V₃H₁₃))/√2, or detection of a pair of photons in an pure two-photon state such as |H_{3′}V_{13′}), where modes 3′ and 13′ are the output modes of a beamsplitter with modes 3 and 13 as inputs.

Receiver Bob 11 measures the qubit state of photons received in mode 5 and has a detector, the second detector to detect these photons. The basis for Bob's measurement may be the logical qubit basis, or rotation thereof. For photonic qubits encoded in the polarisation degree of freedom, with horizontal (H) polarisation corresponding to 0, and vertical (V) polarisation corresponding to 1, this corresponds to a measurement distinguishing between H and V polarisation, or some basis rotation such as between left (L) and right (R) or diagonal (D) and anti-diagonal (A) polarised photons.

Bob also measures the detection time of the received photon, relative to those detected by Alice. This may be achieved by detection times measured by Alice and Bob relative to the same clock, relative to separate synchronised clocks, or relative to timing signals generated by detection events.

In this embodiment, teleportation is achieved using time-based post-selection using the above mentioned timing unit and a controller. Teleportation may generally only be achieved when a photon in mode 13 is detected by Alice at the same time as a photon in mode 3, which was generated at the same time as a photon in mode 5, detected by Bob.

The first stage of ensuring these conditions are met is by post-selecting events where the time difference between photons detected in a joint measurement by Alice 9, the first delay, is sufficiently close to zero, for example within the coherence time of photons in modes 13 and 3.

Information which records the time of such successful coincidences measured by Alice is transmitted to Bob via classical communication link 15, which could be for example an Internet connection.

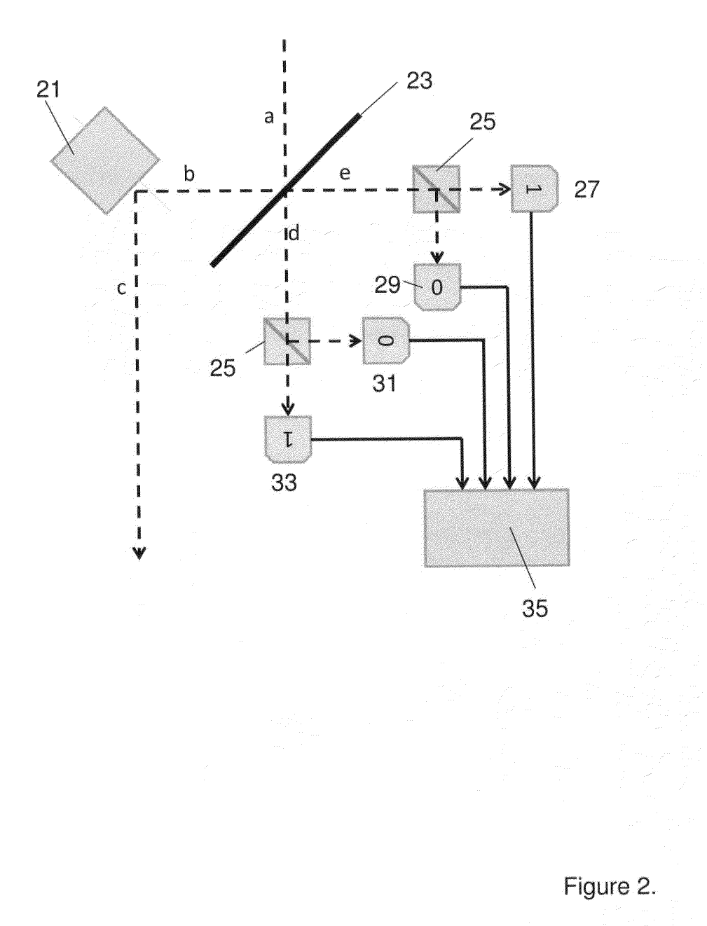

Dependent on the configuration of the joint measurement, it may also be necessary for Alice to additionally transmit the measurement outcome to ensure that the correct transformation is applied prior or after Bob's measurement to photons in mode 5, in order to reproduce the input state in mode 15. This will be explained in more detail with reference to FIG. 2.

Finally, a controller performs post-selection based on the measurement time of photons in mode 5, relative to successful, post-selected, joint measurement times communicated from Alice via classical channel 17. Photons in mode 5 may be identified as being emitted at similar times to the photon formerly in mode 3 and detected by Alice, using the relative detection time between Bob's photon and Alice's joint measurement, and also the relative delays in the system due to the propagation times down modes 3 and 5 and the measurement apparatus of Alice and Bob.

FIG. 2 shows the operation principles of an experimental implementation of the present invention. Photonic qubits are encoded in the polarisation degree of freedom, and an arbitrary input photon qubit state Φₐ, in mode a may be written as;

Φₐ=α|0 [symbol] ₐ+β|1 [symbol] ₐ

In addition, and entangled photon pair state |Ψ [symbol] _{bc} is generated by entangled light source 21, which are distributed amongst modes b and c, written as;

|Ψ [symbol] _{bc}=(|0_{b}0_{c} [symbol] +|1_{b}1_{c} [symbol] )/\sqrt{2}

The three-photon input state is |Φ [symbol] ₐ [symbol] |Ψ [symbol] _{bc} where:

|Φ [symbol] ₐ [symbol] |Ψ [symbol] _{bc} ∝α|0ₐ0_{b}0_{c} [symbol] +α|0ₐ1_{b}1₁_{c} [symbol] +β|1ₐ0_{b}0_{c} [symbol] +β|1ₐ1_{b}1_{c}

[symbol]

Modes a and b overlap at 50/50 beamsplitter 23, which assuming photons in modes a and b are indistinguishable except for polarisation, and accounting for phase changes upon reflection, yields the following, 3-photon output state upon detection of a single photon in modes d and e.

|Ψ [symbol] _{deb} ∝(|0_{d}1ₑ [symbol] −|1_{d}0ₑ [symbol] )(α|1 [symbol] _{c}−β|0 [symbol] _{c})

Usually, the joint measurement performed is detection of a single photon in mode d and a single photon in mode e. This is often referred to a Bell measurement, and in the ideal case, the photons in modes d and e are indeed in the entangled Bell state (|0_{d}1ₑ [symbol] −|1_{d}0ₑ [symbol] )/\sqrt{2}.

In real systems, linear optics are not perfect and although, for example, a 50:50 beam splitter may be used, typically such a beam splitter will not be perfect. Such imperfections will cause some small variations to the Bell States such that they are not true and perfect Bell states.

Also, to avoid any confusion, the term Bell state is used to mean the pure Bell states and mixtures of Bell states, for example Werner states.

After joint measurement of the first two photons, the output state is Φ_{c}=α|1 [symbol] _{c}−β|0 [symbol] _{c}. This qubit state is the same is the input state, apart from a simple unitary transformation of a bit-flip and phase change, which can be compensated for using logic or physical rotation of the output photons with a polarisation controller. The joint measurement implemented using a beamsplitter with an entangled photon pair and input photon thus performs quantum teleportation.

In the above embodiment, an electrically driven entangled light source is used. The emitted photons of such sources may have a poor coherence time. This may result in partial distinguishability between photons in modes a and b, which will no longer maximally interfere at the beamsplitter. In this case, some of the photons in modes e and d will not give rise to successful teleportation, and will degrade the overall quality, or fidelity, of teleported photons. For example, there will be contributions from pairs of photons of the same polarisation in modes e and d.

In one embodiment, these can be eliminated by additionally performing a state measurement, using a state measurement unit, for example the polarisation of the photons in modes e and d may be measured using polarising beamsplitters 25 and 27. Ensuring coincident detection of a photon in modes e and d are oppositely polarised, by accepting events from photon detector combinations 27 and 31 or 29 and 33, removes these unwanted coincidences, and improves the teleportation fidelity. In other types of sources for example, laser-driven entangled light sources such as parametric down converters, the coherence time is typically manipulated to acceptable levels at the expense of efficiency.

Timing unit 35 measures the time between photons registered by each of the detectors 27, 29, 31, and 33 in order to determine the first delay time. Successful coincidences are selected for communication to Bob if the first delay time between photons is below a first threshold, and the polarisation combination is correct.

In an embodiment, the first threshold is set at the coherence time, which for an entangled light emitted diode is typically around 200 ps. In a further embodiment, an improved source could be used which would have coherence time twice the radiative lifetime, which could be around 2 ns.

Suitable polarisation combinations are any where the two photons have opposite polarisation, and are thus combinations of photons in different modes registered by detectors 27 with 31 and 29 with 33, or combinations of photons in the same modes registered by detectors 27 with 29 and 31 with 33. Since, to detect e.g. 27 and 29 requires 1 H and 1 V photon in mode e. This can be achieved by H in mode a reflected, and V in b transmitted, or V in a reflected and H in b transmitted. Superposition of these states, which have the same phase transformation through the beamsplitter, means the input is (|HₐV_{b} [symbol] +|VₐH_{b} [symbol] )/\sqrt{2}, i.e. another Bell state. Note that a joint measurement of a pair of oppositely polarised photons in the same mode e or d creates the output qubit state Φ_{c}=α|1 [symbol] _{c}+β|0 [symbol] _{c}, which requires only a bit-flip to recreate the input qubit.

Preferably, all four combinations referred to above of oppositely polarised photon detection in modes e or d are used to perform a joint measurement. However, any subset is also possible, albeit achieving teleportation with lower probability. In the experiments below only one of the combinations is selected, corresponding to 0 in mode e and 1 in mode d. In an embodiment, with ⅛ efficiency for each combination, and two Bell states to keep track of, the theoretical maximum Bell state measurement efficiency of 0.5 could be reached.

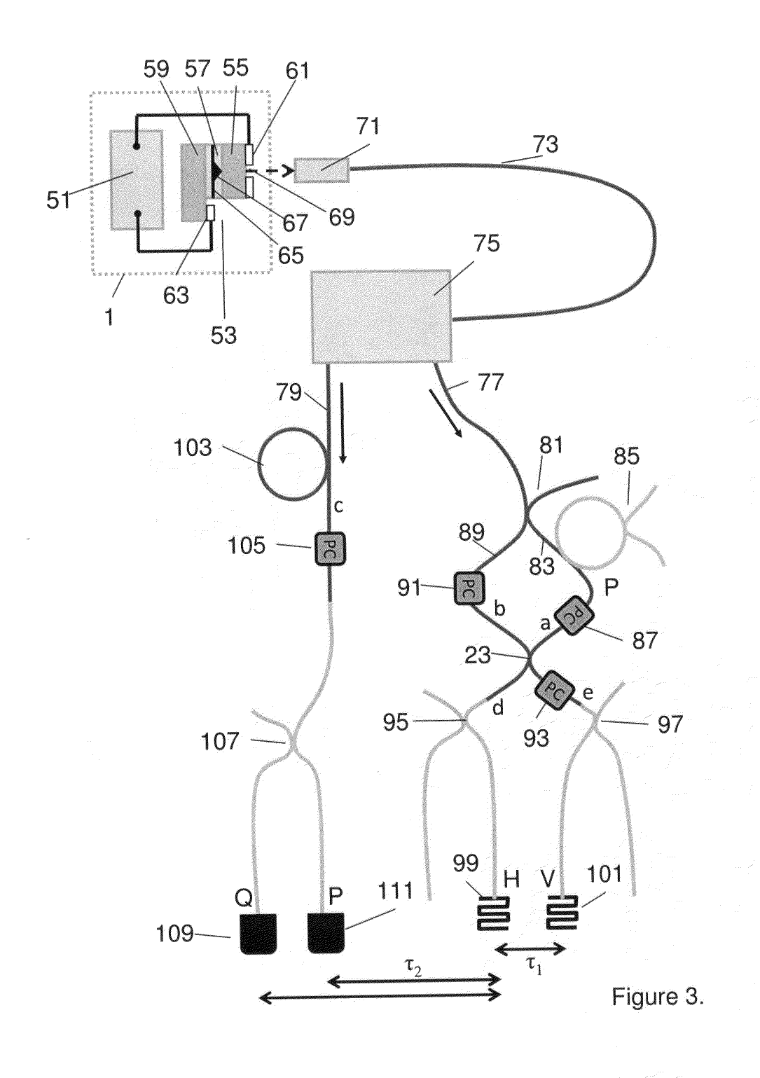

FIG. 3 shows a complete experimental teleportation system. Continuously electrically driven entangled light source 1 consists of d.c. current/voltage source 51 and entangled light emitting diode (ELED) 53. ELED 53 comprises carbon p-doped top GaAs/AlAs Bragg reflector 55, intrinsic doped GaAs cavity layer 57, and silicon n-doped bottom GaAs/AlAs Bragg reflector 59. Current is injected via contacts 61 and 63, to create electrons and holes that relax into quantum-well-like InAs wetting layer 65, and InAs quantum dot 67. Quantum dot 67 generates entangled photons by radiative decay of the biexciton (XX) state consisting of two electrons and two holes, via the exciton state (X) consisting of one electron and hole, to the empty ground state. An aperture 69 in contact 61 allows photons to escape.

In an embodiment, the above ELED is based on self-assembled InAs quantum dots placed in the intrinsic region of a GaAs p-i-n junction grown by molecular beam epitaxy The relatively thick (˜400 nm) intrinsic region suppresses charging of the X state and ensures that the neutral X and XX states are dominant. Two top and 14 bottom Al_{0.98}Ga_{0.02}As/GaAs distributed Bragg mirror pairs create a planar 2λ optical cavity which enhances the light collection efficiency around the X and XX emission wavelengths. Mesas of size 360×360 μm² were etched to define individual ELED devices and a metal mask with ˜2 μm diameter apertures placed on top of each device to isolate individual dots optically and serve as a p-type electrical contact.

The device was cooled to ˜16K in a liquid helium cryostat and electrically excited by injecting a d.c. current density of 93 nAμm⁻², which gives roughly equal X and XX intensities

In an embodiment, in order for XX and X photons emitted in the same radiative cascade to be entangled in polarisation the fine structure splitting (FSS) of the intermediate X state of the quantum dot must be close to zero. The FSS for the dot used here was characterized by linear polarisation-dependent electroluminescence spectroscopy and found to be 2.0±0.2 μeV. The X and XX emission was verified to be unpolarised within error.

Photons emitted by the ELED are collected by lens 71 and coupled into single mode fibre 73. XX and X photons are separated into different modes using wavelength dependent distribution unit 75, which may be implemented using an optical grating. The two output modes are coupled to single mode fibres 77 and 79, so that XX photons travel along fibre 77 towards Alice, and X photons travel down fibre 79 towards Bob.

In this experiment, the input qubit is generated by the same ELED as the entangled photons, though the input qubit may in general originate from another source. To achieve this, the stream of XX photons in fibre 77 is divided using 50/50 beamsplitter 81, which is implemented using an evanescent fibre 2×2 coupler. On one splitter output 83, the emission is polarised using fibre polarising beam splitter 85, which also introduces a delay of ˜2.5 ns. The input polarisation is then chosen using polarisation controller 87 to produce a photonic input qubit in mode a.

A pair of entangled photons travel in modes b and c, with the XX photon in mode b originating from the other output port 89 of beamsplitter 81. Polarisation controller 91 corrects any transformation of the photon polarisation state caused by the fibres, so that a H polarised XX photon collected by lens 71 remains H polarised at the output mode d after 50/50 beamsplitter 23. Similarly, polarisation controller 93 corrects polarisation transformation for the output of mode e.

Polarising fibre beamsplitters 95 and 97 perform polarisation discrimination for the joint measurement of a single photon in mode d and one in mode e by Alice. Superconducting single photon detectors (SSPDs) 99 and 101 detect H polarised photons in mode d, and V polarised photons in mode e respectively, performing a joint measurement to allow teleportation. The time between detection times of such photon pairs (the first delay time) is recorded and denoted τ₁.

Bob's apparatus consists of fibre delay 103, to ensure the joint measurement is performed prior to detection of the output qubit, and polarisation controller 105, to select the polarisation basis for Bob's measurement on the output qubit in mode c. For a P polarised input qubit, Bob's measurement basis is selected so that polarising fibre beamsplitter 107 can discriminate between polarisations P and Q, where Q is orthogonal to P. Bob uses avalanche photodiodes (APDs) 109 and 111 to detect single output photons, and their arrival time relative to a H polarised detection event recorded by Alice. This time difference, the second delay time, is denoted τ₂.

The choice of SSPDs to measure τ₁ is due to their fast response time, which enables precision sufficient to detect time differences within the coherence time of the emitted photons, which in this example is ˜200 ps. Less precision is required in the measurement of τ₂, as strong entanglement is expected for X photons emitted up to 1 ns after a XX photon due to small FSS, slow re-excitation, and the XX and X radiative lifetime. Therefore APDs are suitable detectors for Bob, as though they are less precise, they have higher efficiency compared to SSPDs.

FIG. 4a shows experimentally measured XX and X photon statistics in fibres 77 and 79. The measurement performed is a standard Hanbury Brown and Twiss type, from which we determine the second order correlation g⁽²⁾, as a function of the time delay τ between detected photons. For X or XX photons emitted more than a few ns apart, g⁽²⁾ is approximately 1, signifying a continuous stream of photons, with random time delay between emission of a pair of XX or X photons. However, around τ=0, a clear anti-bunching dip is observed for both XX and X emission, signifying a suppressed probability of generating two XX or X photons at the same time. The residual g⁽²⁾ at τ=0 is approximately 0.1, and is attributed to the finite time resolution of our detectors, with the underlying g⁽²⁾ expected to be close to zero.

In contrast, for a Poissonian light source such as a laser, or the individual output beams of a parametric down conversion (PDC) entangled light source, g⁽²⁾ τ=0 is expected to remain 1, as indicated by the dashed line. PDC light sources are therefore not anti-bunched in contrast to the light sources used in systems in accordance with embodiments of the present invention.

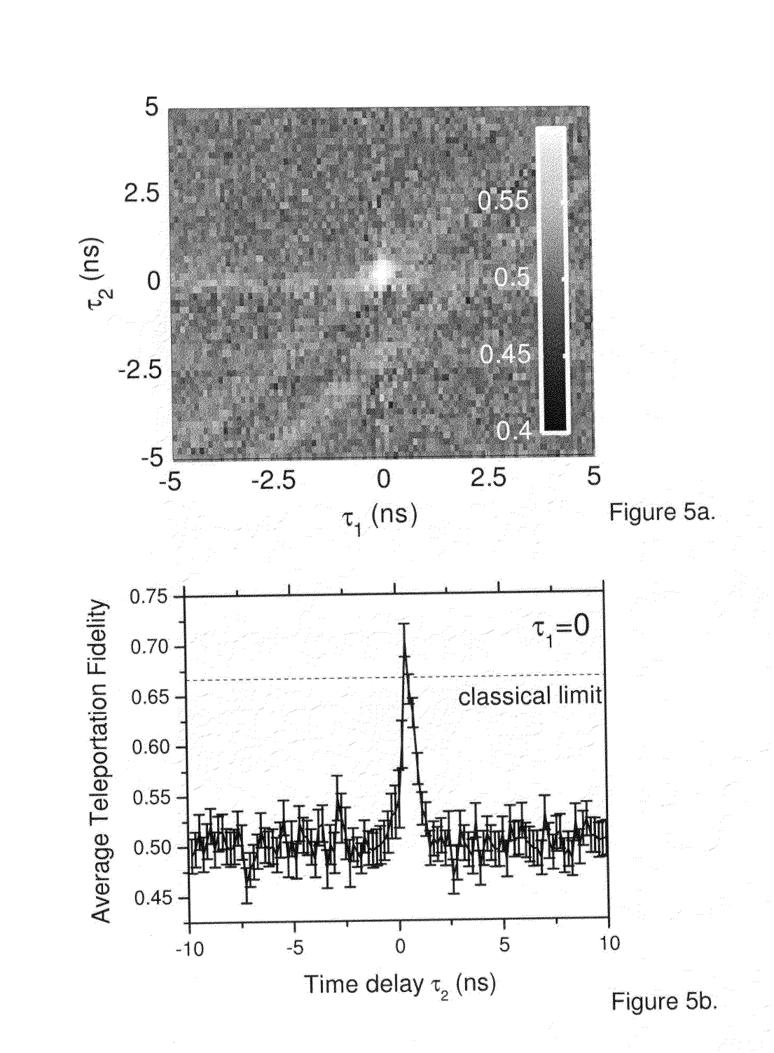

FIGS. 5a and b show results demonstrating successful teleportation of photonic qubits using a system in accordance with an embodiment of the present invention.

Three-photon coincidences g⁽²⁾(τ₁, τ₂) are measured corresponding to photon detection by SSPD_{H}, SSPD_{V}, and APD_{P} or APD_{Q}, where τ₁ is the time difference between detection by SSPD_{V} and SSPDH, and τ₂ is the time difference between detection by SSPD_{H} and APD_{P} or APD_{Q}. The fidelity for teleportation of an input qubit with polarisation P onto an output qubit with ideal expected polarisation P′ (orthogonal to Q′) is given by;

f_{P}^{T}(τ₁,τ₂)=g_{P,P′}⁽³⁾(τ₁,τ₂)/(g_{P,P′}⁽³⁾(τ₁,τ₂)+g_{P,Q′}⁽³⁾(τ₁,τ₂))

As the input polarisation P may be selected from an infinite set, an averaged teleportation fidelity measurement f^{T} is often used, where averaging is across 6 states from 3 mutually unbiased bases. In practice this translates to the averaging of the teleportation fidelity across 6 experiments, where the input state polarisations are horizontal (H), vertical (V), diagonal (D), anti-diagonal (A), left-hand circular (L) and right-hand circular (R). These states are shown in FIG. 4b on the Poincarré Sphere, which allows any polarisation state to be represented and visualised. In our examples the logical basis corresponds to the polar states H and V, and the states D, A, L, and R, which lie on the equatorial plane of the Poincarré sphere, are therefore logical superposition states and may be written as D=(H+V)/√2, A=(H−V)/√2, L=(H+iV)/√2 and R=(H-iV)/√2.

The average teleportation fidelity for the 6 input states is plotted in FIG. 5a as a function of the measured time delays τ₁ and τ₂. A high fidelity spot is observed at the centre of the figure, indicating that post selecting measurements based on the time delay between detected photons by Alice, and the time between a photon detected by Alice and Bob, is sufficient to allow teleportation. Note that the zero time on axis τ₂ is arbitrarily defined to correspond to photon events where the ancilla and target photons were generated at the same time. A large time difference may exist in an application between detection events, but this is manifested only by a linear shift of all data in τ₂, and a high fidelity spot can always be post-selected.

FIG. 5b shows the average teleportation fidelity plotted as a function of the second time delay, measured as the delay between Alice and Bob's photon detection τ₂, when τ₁=0. This constitutes a vertical slice through the data in FIG. 5a. A peak is observed in teleportation fidelity when the correct value, zero, of τ₂ is selected. In this case, the peak average fidelity measured is 0.704±0.016, which exceeds the maximum value of ⅔ achievable using non-entangled light sources by 2.2 standard deviations, thus proving quantum teleportation has occurred.

In the above embodiment, teleportation of single photonic qubits, mediated by individual pairs of entangled photons generated by an electrically driven entangled light source has been demonstrated. This is realized by embedding a single semiconductor quantum dot within a light-emitting-diode, resulting in anti-bunched emission and elimination of multi-photon errors. The average fidelity across 6 different input states is measured to be 0.70, above the classical limit. The unique single-photon nature of the photonic teleporter together with its electrical operation will help lift the complexity restriction of achievable future applications.

The systems described above provides full teleportation of arbitrary unknown photonic qubits which is ideally suited to distributed quantum computing and networking. However, until now such experiments have used light sources that produce random numbers of input-qubits. Teleportation has been demonstrated with a semiconductor quantum light source that emits no more than one photon or entangled photon pair simultaneously. The light source is electrically driven, which will offer a significant practical advantage when constructing complex quantum logic circuits.

Teleportation of optical qubits can allow consistent logic operations in massively parallel quantum computers, and the formation of secure quantum networks. Photon teleportation has previously employed laser-generated entangled photons created in random quantities. However, practical complexities of the generating scheme coupled with balancing the opposing requirements of high efficiency and infrequent multi-pair emission, restricts deployment in useful quantum information technology. Sources based on parametric down conversion within laser-excited non-linear crystals, are not directly electrically driven and exhibit no suppression in probability of generating two photons simultaneously in a given mode.

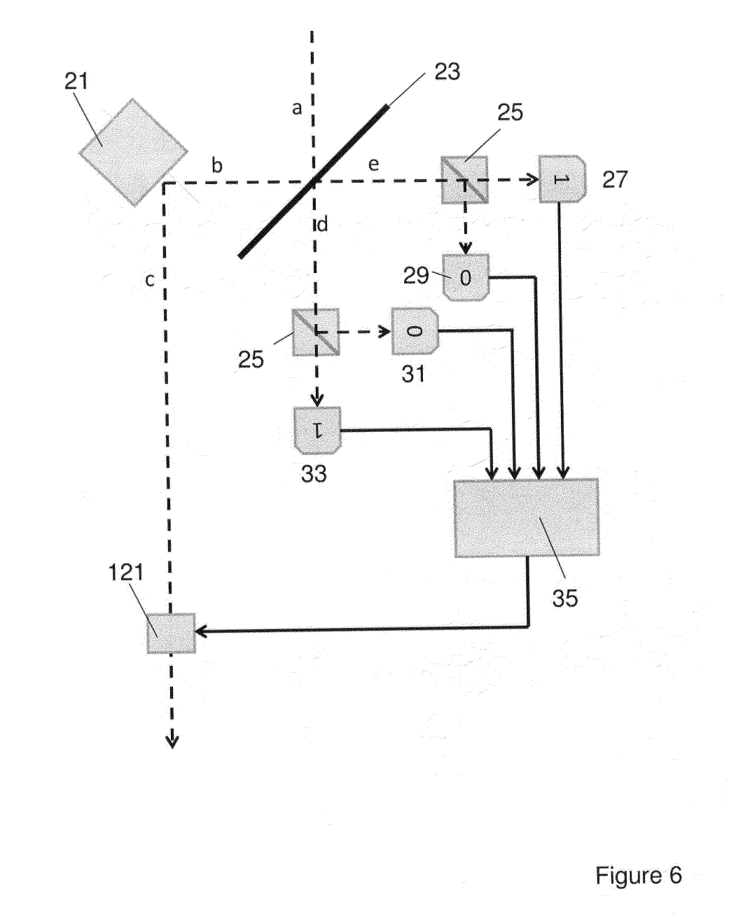

FIG. 6 shows a variation of the teleportation system. The embodiments described above post-select the time difference between output photons and the joint measurement τ₂ by measuring the output photons with a detector. However, said time-difference may also be selected by blocking photons using a blocking unit in the output beam except for those occurring at a desired time, wherein the desired time is when a photon which satisfies the second delay time limit is expected to arrive. This may be achieved by Alice communicating with, or controlling, photon blocking unit 121, causing photons to be blocked except at times corresponding to detection of a simultaneously generated first or ancilla photon by Alice. For example, if the time delay for an ancilla photon to travel from the source to Alice's detectors was Δt_{A}, and the delay between the source and the blocking device Δt_{B}, then upon a successful joint detection event by Alice with τ₁=0, Alice would cause the blocking device to open at time approximately Δt_{B}−Δt_{A} later, for a short amount of time. The time that the blocking device remains open should for example be similar to the width of the high fidelity region in FIG. 5b, which is the order of 1 ns for the prototype source.

In an embodiment, only photons with high teleportation fidelity post-selected by Alice will be allowed to pass. Such photons could be measured immediately, or transferred to another party or application. In one embodiment, the blocking unit will only allow the passage of photons at the desired time if Alice has already made a joint measurement and the results from the first delay time suggests that teleportation may have occurred. In further embodiments, Alice will only instruct the blocking unit to allow the passage of photons if her measurements of the polarisation of the photons which have undergone joint measurement suggest that teleportation has occurred.

The blocking device could be constructed from a variety of standard components, including an electro-optic-modulator or interferometer.

While certain embodiments have been described, these embodiments have been presented by way of example only, and are not intended to limit the scope of the inventions. Indeed the novel methods and apparatus described herein may be embodied in a variety of other forms; furthermore, various omissions, substitutions and changes in the form of methods and apparatus described herein may be made without departing from the spirit of the inventions. The accompanying claims and their equivalents are intended to cover such forms of modifications as would fall within the scope and spirit of the inventions.

1. A system for quantum teleportation of a quantum state of an input photon, the system comprising:
a light emitting diode configured to produce a polarisation entangled photon pair;
a beam splitter configured to direct one photon of an entangled photon pair along a first path and the other photon of said entangled pair along a second path;
an input for said input photon;
a measurement unit for performing a joint measurement on the input photon with one of the photons of an entangled photon pair directed along the first path, the measurement unit comprising a first detector unit for detecting two photons upon which a joint measurement has been performed;
a second detector unit configured to detect the photon from said entangled photon pair directed along the second path;
a timing unit is configured to measure a first delay, said first delay being the delay between the input photon and the photon of the entangled photon pair at the point of maximum indistinguishability of the photons as they pass through the joint measurement unit, the timing unit being further configured to measure a second delay, said second delay being the delay time between the two photons of the entangled photon pair as they exit the light emitting diode; and
a controller configured to determine that a teleportation measurement is valid if the first delay is within a first predetermined timing window and the second delay is within a second predetermined timing window.

2. A system according to claim 1, further comprising an electrical source for said light emitting diode and wherein said electrical source is a D.C. source.

3. A system according to claim 1, wherein said timing unit is configured to determine the first delay time from the detection time of the said two photons by the first detector unit, the timing unit also being configured to compensate for variations between the path lengths from the point where the respective spatial modes of the two photons meet in the joint measurement unit to the first detector unit.

4. A system according to claim 1, wherein the joint measurement unit comprises a beam splitter to permit two-photon-interference and wherein said timing unit is configured to determine the first delay time from the detection time of the said two photons by the first detector unit, the timing unit also being configured to compensate for variations between the path length taken by the two photons from the beam splitter to the first detector unit.

5. A system according to claim 1, wherein the timing unit is configured to measure the second delay from the time when the photon which follows the second path is received at the second detector, the timing unit being further configured to compensate for differences in path lengths taken by the two photons of the entangled photon pairs.

6. A system according to claim 1, wherein the system further comprises a blocking unit located in the second path, said timing unit being configured to operate said blocking unit to allow the transmission of a photon along the second path if the second delay time is within the second timing window.

7. A system according to claim 1, further comprising a blocking unit located in the second path, said timing unit being configured to operate said blocking unit to block the transmission of a photon along the second path unless said controller has determined that the first delay time is within the first timing window.

8. A system according to claim 1, wherein the joint measurement is a measurement involving Bell states or mixtures with Bell states.

9. A system according to claim 1, further comprising a state measurement unit configured to perform state measurements on both of the photons which pass through the joint measurement unit and wherein the controller determines that the teleportation measurement is valid if, additionally the state measurements on both photons agree with at least one of a predetermined set of results.

10. A system according to claim 1, wherein the controller is configured to allow post measurement selection of valid measurements.

11. A system according to claim 1, wherein the first detector unit comprises first and second detectors, the first and second detectors being superconducting detectors.

12. A system according to claim 1, wherein said second timing window is from 0 to t₂ₘₐₓ, where t₂ₘₐₓ is of the order of the exciton radiative lifetime.

13. A system according to claim 1, wherein the first timing window is from 0 to t₁ₘₐₓ, where t₁ₘₐₓ is the coherence time of the photon which follows the first path.

14. A system according to claim 1, wherein the system is configured to allow the light emitting diode to provide the input photon.

15. A system according to claim 14, further comprising a input photon delay unit and a switch, said switch being configured to direct a photon from the first path into the said input photon delay unit, wherein in the input photon delay unit, the photon from the said source is delayed to coincide with a further photon output by the source such that the photon which is delayed becomes the input photon.

16. A system according to claim 1, wherein the state to be teleported is a superposition state.

17. A system according to claim 1, wherein said light emitting diode comprises a quantum dot.

18. A quantum computer comprising a teleportation system according to claim 1.

19. A quantum communication relay comprising a teleportation system according to claim 1.

20. A method of teleporting of a quantum state of an input photon, the method comprising:
providing a polarisation entangled photon pair from a light emitting diode;
directing one photon of the entangled photon pair along a first path and the other photon of said entangled pair along a second path;
providing an input photon;
performing a joint measurement on the input photon with one of the photons of an entangled photon pair directed along the first path and detecting the two photons upon which a joint measurement has been performed;
detecting the photon from said entangled photon pair directed along the second path;
measuring a first delay, said first delay being the magnitude of the delay between the input photon and the photon of the entangled photon pair at the point of maximum indistinguishability of the photons as they undergo joint measurement,
measuring a second delay, said second delay being the magnitude of the delay time between the two photons of the entangled photon pair as they exit the light emitting diode; and
determining that a teleportation measurement is valid if the first delay is within a first timing predetermined window and the second delay is within a second predetermined timing window.
